(19) United States
(12) Patent Application Publication
(10) Pub. No.: US 2015/0079388 A1
(43) Pub. Date: Mar. 19, 2015

(54) PRESSURE-SENSITIVE ADHESIVE SHEET FOR FASTENING POLISHING PAD

(71) Applicant: NITTO DENKO CORPORATION, Osaka (JP)

(72) Inventors: Hiroyuki SUZUKI, Osaka (JP); Shuuhei YAMAMOTO, Osaka (JP)

(73) Assignee: NITTO DENKO CORPORATION, Osaka (JP)

(21) Appl. No.: 14/484,475

(22) Filed: Sep. 12, 2014

(30) Foreign Application Priority Data
Sep. 13, 2013 (JP) 2013-190489

(51) Int. Cl. C09J 7/00; B24B 37/34

(52) U.S. Cl. CPC C09J 7/00; B24B 37/34; C09J 153/00
USPC 428/354; 525/92 D

(57) ABSTRACT

This invention provides a polishing pad-fastening pressure-sensitive adhesive sheet capable of tightly fastening a polishing pad. The polishing pad-fastening pressure-sensitive adhesive sheet comprises a pressure-sensitive adhesive layer constituting an adhesive face of the pressure-sensitive adhesive sheet. The adhesive face exhibits a 180° peel strength of 30 N/20 mm or greater relative to a stainless steel plate.

### CROSS-REFERENCE

The present application claims priority to Japanese Patent Application No. 2013-190489 filed on Sep. 13, 2013, and the entire contents thereof are incorporated herein by reference.

### BACKGROUND OF THE INVENTION

1. Field of the Invention

The present invention relates to a pressure-sensitive adhesive (PSA) sheet used for fastening a polishing pad.

2. Description of the Related Art

In liquid crystal display glasses, silicon wafers, hard disks, etc., highly smooth surfaces are generally obtained by polishing. Polishing in such technologies is performed, for instance, such that an article to be polished is set on a polishing machine, and while supplying a polishing slurry containing an abrasive, a polishing pad attached to the polishing machine's surface plate is pushed against the article and both the article and polishing pad are moved in parallel to the article's surface. The polishing pad used for polishing is usually attached and fastened with adhesive to the polishing machine's surface plate. However, the use of adhesive involves some problems in terms of workability during attachment and fastening, such as requiring drying time, evaporation of organic solvent(s) during the drying process, etc. Accordingly, attachment and fastening with PSA instead of adhesive have been investigated. For example, literatures disclosing conventional art using PSA sheets as polishing pad-fastening means include Japanese Patent Application Publication Nos. 2012-57135 and 2012-102165.

### SUMMARY OF THE INVENTION

Reasonable adhesiveness is required of a PSA sheet used for attaching and fastening a polishing pad. Nevertheless, conventional PSA sheets are yet to bring about sufficient adhesive strength relative to polishing pads. For instance, from the standpoint of increasing the productivity or reducing the cost, etc., under conditions demanding a longer lasting polishing pad with less frequent polishing pad replacement, it will be useful to have a PSA sheet that bonds more tightly to a polishing pad throughout the period of its use.

The present invention has been made in view of the circumstances thus far, with an objective thereof being to provide a polishing pad-fastening PSA sheet capable of securely fastening a polishing pad.

This invention provides a polishing pad-fastening PSA sheet. The PSA sheet comprises a PSA layer constituting an adhesive face of the PSA sheet. The adhesive face exhibits a 180° peel strength of 30 N/20 mm or greater relative to a stainless steel plate. A PSA sheet exhibiting such peel strength (SUS adhesive strength) can tightly bond to a polishing pad. Thus, the present invention provides a PSA sheet particularly suitable for fastening a polishing pad. The PSA sheet disclosed herein can exhibit a high level of adhesive strength that has not been conventionally available with respect to a hard urethane-based polishing pad (e.g. polyurethane-based foam polishing pad). Therefore, it is used particularly preferably for fastening a hard urethane-based polishing pad (e.g. polyurethane-based foam polishing pad).

In a preferable embodiment of the PSA sheet disclosed herein, the PSA layer comprises, as a base polymer, a block copolymer of a monovinyl-substituted aromatic compound and a conjugated diene compound. In particular, the base polymer is preferably a styrene-based block copolymer.

In a preferable embodiment of the PSA sheet disclosed herein, the PSA layer comprises a tackifier resin. The tackifier resin preferably comprises a high softening point resin having a softening point of 120° C. or above. The high softening point resin preferably comprises a terpene phenol resin. Preferably, the tackifier resin further comprises a low softening point resin having a softening point below 120° C.

In a preferable embodiment, the PSA sheet disclosed herein is constituted as an adhesively double-faced PSA sheet comprising a substrate, a first PSA layer provided as the aforementioned PSA layer on a face of the substrate, and a second PSA layer provided on the other face of the substrate. In the double-faced PSA sheet, it is preferable that the first PSA layer's adhesive face is to be adhered to a polishing pad while the second PSA layer's adhesive face is to be adhered to a surface plate of a polishing machine.

The present invention provides a polishing pad to which a PSA sheet (polishing pad-fastening PSA sheet) disclosed herein has been adhered. A surface of the polishing pad is bonded to an adhesive face of the PSA sheet. In a preferable embodiment, the PSA sheet is constituted as a double-faced PSA sheet wherein another adhesive face (second adhesive face) placed opposite of the adhesive face (first adhesive face) may be bonded to a polishing machine's surface plate.

### BRIEF DESCRIPTION OF THE DRAWINGS

FIG. 1 shows a schematic side view illustrating an application example of a polishing pad-fastening PSA sheet according to an embodiment.

FIG. 2 shows a schematic cross-sectional view illustrating the constitution of a PSA sheet (on-substrate, double-faced PSA sheet) according to an embodiment.

FIG. 3 shows a schematic cross-sectional view illustrating the constitution of a PSA sheet (substrate-free, double-faced PSA sheet) according to one of other embodiments.

FIG. 4 shows a schematic cross-sectional view illustrating the constitution of a PSA sheet (on-substrate, single-faced PSA sheet) according to one of other embodiments.

FIG. 5 shows a diagram schematically illustrating a method for measuring the shear adhesive strength.

### DETAILED DESCRIPTION OF THE INVENTION

Preferred embodiments of the present invention are described below. Matters necessary to implement this invention other than those specifically referred to in this description may be understood as design matters to a person of ordinary skill in the art based on the conventional art in the pertinent field. The present invention can be implemented based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not represent the accurate sizes or reduction scales of a PSA sheet provided as an actual product.

As used herein, the term “PSA” refers to a material that exists as a soft solid (a viscoelastic material) in a room temperature range and has a property to adhere easily to an adherend with some pressure applied. As defined in “Adhesion: Fundamental and Practice” by C. A. Dahlquist (McLaren & Sons (1966), P. 143), PSA referred to herein is a material that has a property satisfying complex tensile modulus E* (1 Hz)<10⁷ dyne/cm² (typically, a material that exhibits the described characteristics at 25° C.). The term “base polymer” of a PSA refers to the primary component among rubbery polymers (typically polymers that exhibit rubber elasticity in a room temperature range) contained in the PSA, that is, a component accounting for 50% by mass or more of all the rubbery polymers.

### <Applications of PSA Sheet>

The PSA sheet disclosed herein is used for fastening a polishing pad. The polishing pad to which the PSA sheet disclosed herein is applied is not particularly limited. Examples include urethane foam-based (foamed polyurethane-based), polyolefin foam-based (foamed polyolefin-based) and other foamed resin-based polishing pads as well as non-foamed resin-based polishing pads and non-woven fabric-based polishing pads. It may have a layered structure including at least one layer of an aforementioned polishing pad. The PSA sheet disclosed herein is preferably used for fastening a urethane foam-based polishing pad. Although not particularly limited, the PSA sheet disclosed herein can be preferably applied, for instance, to a urethane foam-based polishing pad having a density of 0.3 g/cm³ to 1.2 g/cm³ (typically 0.4 g/cm³ to 1.0 g/cm³). While there are no particular limitations to the hardness of the polishing pad (based on JIS K6400-2 (2004), Method A), either, the PSA sheet disclosed herein is preferably bonded to a polishing pad having a hardness of about 60 N to 120 N (typically 70 N to 100 N). The polishing pad may include abrasive particles fixed therein.

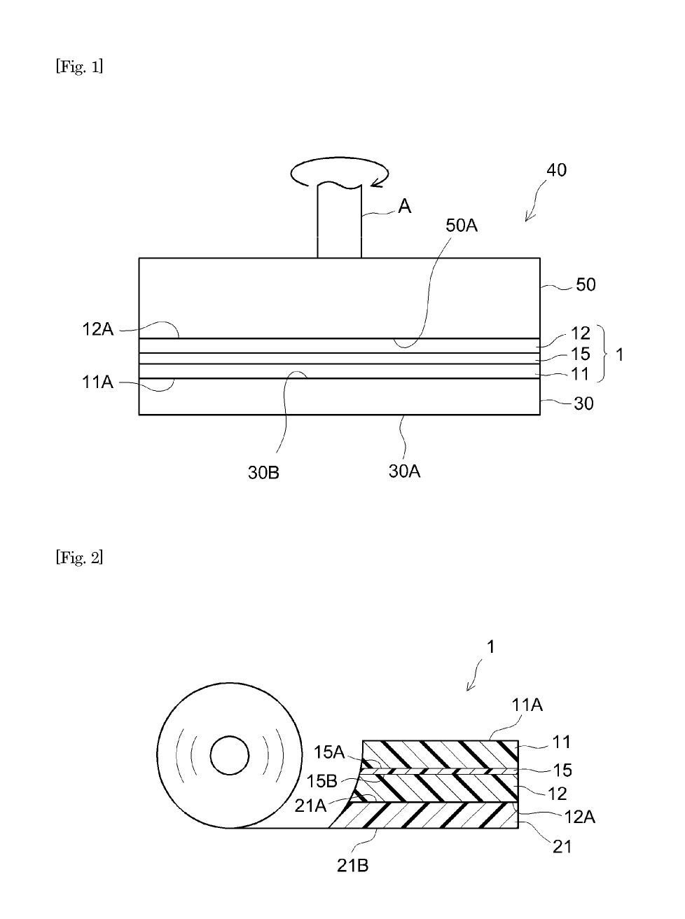

FIG. 1 shows a preferable application example of the PSA sheet disclosed herein. As shown in FIG. 1, PSA sheet 1 is in a form of a double-faced PSA sheet having an adhesive face on each face. In particular, PSA sheet 1 comprises a substrate 15, a first PSA layer 11 placed on a face of substrate 15, and a second PSA layer 12 placed on the other face of substrate 15. Adhesive face (first adhesive face) 11A of the first PSA layer 11 is bonded to a back face 30B of a polishing pad 30. Adhesive face (second adhesive face) 12A of the second PSA layer 12 is bonded to a surface 50A of a surface plate 50 installed in a polishing machine 50. Polishing pad 30 is thus fixed to the polishing machine's surface plate 50 via PSA sheet 1.

For instance, polishing with polishing pad 30 as described above is performed, such that while a shaft A is spinning and a polishing slurry (not shown in the drawing) has been supplied, an abrasive surface 30A of polishing pad 30 fastened to the polishing machine's surface plate 50 is pushed against an article to be polished (not shown in the drawing). After the polishing pad 30 is used for a prescribed period, it is removed from the polishing machine's surface plate 50 (typically detached at the interface between the surface plate 50 and second adhesive face 12A) and replaced with a new polishing pad. Thus, it is desirable that for a prescribed period, the PSA sheet applied for this purpose (for fastening a polishing pad) has properties such as adhesive strength to tightly bond to a polishing pad, properties unsusceptible to degradation of adhesive properties in a polishing environment (e.g. properties unsusceptible to degradation of adhesive properties caused by a polishing slurry at a low pH or at a high pH (chemical resistance)) and so on. From the standpoint of increasing the productivity, etc., the PSA sheet disclosed herein preferably is in a size suitable to the sizes of polishing pads and polishing machine's surface plates which tend to become larger. As such a PSA sheet, for instance, a PSA sheet having a width of about 600 mm to 2500 mm (e.g. 600 mm to 2500 mm, typically 1050 mm to 2500 mm) can be preferably used.

### <Examples of Constitution of PSA Sheet>

The PSA sheet disclosed herein (which can be a long sheet such as tape, etc.) may be in a form of, for example, a double-faced PSA sheet having the cross-sectional structure shown in FIG. 2. The double-faced PSA sheet 1 comprises a substrate 15, a first PSA layer 11 and a second PSA layer 12 supported by the respective two faces of substrate 15. More specifically, on the first face 15A and second face 15 B (both non-releasable) of substrate 15, the first PSA layer 11 and second PSA layer 12 are provided, respectively. Prior to use (before adhered to an adherend), as shown in FIG. 2, double-faced PSA sheet 1 can be in a roll wherein PSA sheet 1 is wound along with release liner 21 having releasable faces of front face 21A and back face 21B. In double-faced PSA sheet 1 in such an embodiment, the surface (second adhesive face 12A) of second PSA layer 12 and the surface (first adhesive face 11A) of first PSA layer 11 are protected with front face 21A and back face 21B of release liner 21, respectively. Alternatively, it may be in an embodiment where first adhesive face 11A and second adhesive face 12A are protected with two separate release liners, respectively.

The art disclosed herein is preferably applied to such a double-faced PSA sheet including a substrate as shown in FIG. 2 and can also be applied to such a double-faced PSA sheet 2 free of a substrate (i.e. not having a substrate) as shown in FIG. 3. Prior to use, double-faced PSA sheet 2 can be, for instance, in an embodiment as shown in FIG. 3 where the first adhesive face 11A and the second adhesive face 11B of substrate-free PSA layer 11 are protected with release liners 21 and 22, respectively, with each release liner comprising a release face at least on the PSA-layer-side surface (front face). Alternatively, it may be in an embodiment without release liner 22, wherein both the two faces of release liner 21 are release faces, and PSA layer 11 is overlaid therewith and wound in a roll so that the back face of release liner 21 contacts and protects second adhesive face 11B.

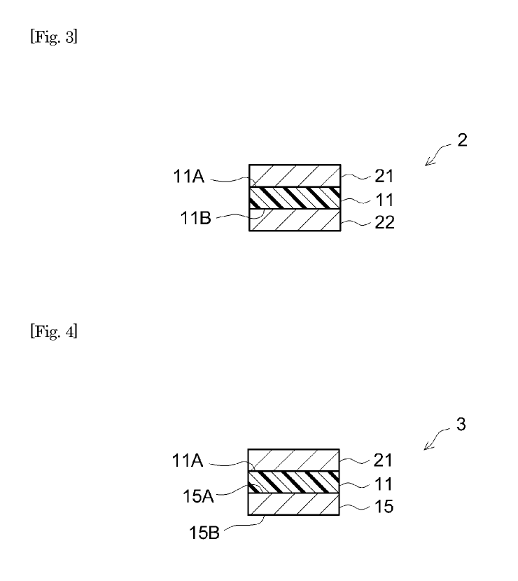

As shown in FIG. 4, the art disclosed herein can be applied to a single-faced, on-substrate PSA sheet 3 comprising a substrate 15 and a PSA layer 11 supported by a first face (non-releasable face) 15A of substrate 15. Prior to use, double-faced PSA sheet 3 can be, for instance, in an embodiment as shown in FIG. 4 where the surface (adhesive face) 11A of the PSA layer 11 is protected with a release liner 21 comprising a release face at least on the PSA-layer-side surface (front face). Alternatively, it may be in an embodiment without a release liner 21, wherein with the use of substrate 15 having a release face on the second face 15B, on-substrate PSA sheet 3 is wound in a roll so that the second face 15 B of substrate 15 contacts and protects the first adhesive face 11A. When such a single-faced PSA sheet is used for fastening a polishing pad, the substrate-side surface is fastened with a different fastening means (e.g. adhesive) to a polishing machine's surface plate, etc.

### <Properties of PSA Sheet>

The PSA sheet disclosed herein is characterized by an adhesive face of a PSA layer in the PSA sheet (for a double-faced PSA sheet, preferably only the adhesive face (first adhesive face) of the first PSA layer) exhibiting a 180° peel strength (or “SUS adhesive strength”) of 30 N/20 mm or greater. Since a PSA sheet exhibiting such SUS adhesive strength can tightly bond to a polishing pad, it is particularly suitable for fastening a polishing pad. The SUS adhesive strength is preferably 32 N/20 mm or greater, or more preferably 34 N/20 mm or greater. The PSA sheet according to a particularly preferable embodiment may have an SUS adhesive strength of 35 N/20 mm or greater (e.g. 36 N/20 mm or greater). The 180° peel strength is measured such that in an environment at 23° C., 50% RH, the adhesive face is pressure-bonded with a 2 kg roller moved back and forth once onto a surface of a stainless steel (SUS) plate as an adherend, left standing for 30 minutes, and then subjected to a measurement based on JIS Z0237 at a tensile speed of 300 mm/min. More specifically, SUS adhesive strength is measured by the method described later in the worked examples.

When the PSA sheet disclosed herein is a double-faced PSA sheet, the adhesive face (second adhesive face) of the second PSA layer preferably has an SUS adhesive strength of 10 N/20 mm or greater (e.g. 12 N/20 mm or greater, typically 16 N/20 mm or greater). A PSA sheet having such an SUS adhesive strength will bond well to a polishing machine's surface plate (typically made of a metal on the bonded surface). Since excessive adhesive strength may result in poorer workability during polishing pad detachment and replacement, the SUS adhesive strength is preferably 30 N/20 mm or less (e.g. 25 N/20 mm or less, typically 20 N/20 mm or less).

In the PSA sheet disclosed herein, the adhesive face of a PSA layer constituting the PSA sheet (for a double-faced PSA sheet, preferably only the adhesive face (first adhesive face) of the first PSA layer) preferably exhibits a post-NaOH(aq)-immersion SUS adhesive strength approximately equal to or greater than the aforementioned SUS adhesive strength. Herein, the term “post-NaOH(aq)-immersion SUS adhesive strength” refers to an SUS adhesive strength measured after the following procedure: in an environment at 23° C., 50% RH, the adhesive face is pressure-bonded with a 2 kg roller moved back and forth once to a stainless steel (SUS) plate as an adhered and immersed in an aqueous NaOH solution adjusted to pH 11 at 50° C. for three days. A PSA sheet exhibiting such a post-NaOH(aq)-immersion SUS adhesive strength has excellent chemical resistance and thus is particularly suitable for fastening a polishing pad that can be exposed to a polishing slurry. The post-NaOH(aq)-immersion SUS adhesive strength is usually suitably 25 N/20 mm or greater (e.g. 28 N/20 mm or greater), preferably 30 N/20 mm or greater, or more preferably 35 N/20 mm or greater. The PSA sheet according to a particularly preferable embodiment may exhibit a post-NaOH(aq)-immersion SUS adhesive strength of 40 N/20 mm or greater (e.g. 45 N/20 mm or greater, typically 55 N/20 mm or greater). Most preferably, the post-NaOH(aq)-immersion SUS adhesive strength is 60 N/20 mm or greater. The post-NaOH(aq)-immersion SUS adhesive strength is measured more specifically by the method described later in the worked examples.

The PSA sheet disclosed herein preferably shows a ratio (PS2/PS1) of the post-NaOH(aq)-immersion SUS adhesive strength (PS2) to the SUS adhesive strength (PS1) of 1 or higher. A PSA sheet satisfying the ratio (PS2/PS1) tends to have greater chemical resistance. The ratio value (PS2/PS1) is preferably 1.2 or higher (e.g. 1.5 or higher, typically 1.8 or higher).

In a preferable embodiment, the PSA sheet disclosed herein is such that in a constant load peel test where an adhesive face of a PSA layer constituting the PSA sheet (for a double-faced PSA sheet, preferably each adhesive face) is pressure-bonded to a phenol resin plate as an adherend over a 10 mm wide by 20 mm long bonding area with a 2 kg roller moved back and forth once, left vertically suspended for 30 minutes in an environment at 40° C. and then with a 500 g load applied thereto for one hour in the same environment, the time required for the PSA sheet to peel and fall off the adherend after the load application is 1 hour or longer. A PSA sheet combining this property and an adhesive strength of the prescribed value or greater may be of high performance, combining high levels of adhesive strength and cohesive strength. In a more preferable embodiment, in the constant load peel test, the PSA sheet may result in a displacement distance (mm) of 3 mm or smaller (e.g. 1 mm or smaller, typically 0.5 mm or smaller) at one hour after the load application.

In a preferable embodiment of the PSA sheet disclosed herein, the adhesive face of a PSA layer constituting the PSA sheet (for a double-faced PSA sheet, preferably each adhesive face) may exhibit a liner peel strength (peel strength relative to a release liner) less than 1 N/50 mm (e.g. 0.5 N/50 mm or less, typically 0.4 N/50 mm or less). A PSA sheet satisfying this property may provide excellent workability during application since a liner can be easily removed therefrom. In view of a chance of reduced workability with an excessively small liner peel strength, the liner peel strength is preferably about 0.01 N/50 mm or greater. The liner peel strength can be measured by the following method.

### [Liner Peel Strength]

A double-faced PSA sheet is obtained with release liners adhered thereon with a hand-held roller in an environment at 23° C., 50% RH. The double-faced PSA sheet with release liners is cut to 50 mm wide by about 20 cm long to obtain a measurement sample. The measurement sample is stored in an environment at 100° C. with a 1 kg load applied thereto for one hour and then in an environment at 23° C., 50% RH for one hour. From this, using a tensile tester, in an environment at 23° C., 50% RH, while a release liner is peeled apart at a peel angle of 180° at a tensile speed of 300 mm/min, the force is measured and the maximum value is recorded as the peel strength (N/50 mm-width).

### <Base Polymer>

The PSA (which can be understood as non-volatiles in a PSA composition) constituting a PSA layer in the PSA sheet disclosed herein may comprise one, two or more species of various polymers known in the PSA field including acrylic, rubber-based, polyester-based, urethane-based, polyether-based, silicone-based, polyamide-based, fluorine-based polymers and the Eke. In particular, the PSA is preferably a rubber-based PSA. The rubber-based PSA refers to a PSA comprising a rubber-based polymer as a base polymer. Examples of rubber-based polymers include natural rubbers, styrene-butadiene rubbers (SBR), acrylonitrile-butadiene rubbers (NBR), isoprene rubbers, chloroprene rubbers, polyisobutylene, butyl rubbers, reclaimed rubbers and the like. These can be used singly as one species or in combination of two or more species.

The PSA in the art disclosed herein is preferably a rubber-based PSA comprising a block copolymer of a monovinyl-substituted aromatic compound and a conjugated diene compound as the base polymer. Herein, the term “block copolymer of a monovinyl-substituted aromatic compound and a conjugated diene compound” refers to a polymer comprising at least one each of a segment (segment A) that comprises a monovinyl-substituted aromatic compound as a primary monomer (which refers to a copolymer component accounting for more than 50% by mass; the same applies hereinafter) and a segment (segment B) that comprises a conjugated diene compound as a primary monomer. In general, the glass transition temperature of segment A is higher than that of segment B. Examples of a typical constitution of such a polymer include an ABA triblock copolymer having a triblock structure where segment B (soft segment) is coupled to segment A (hard segment) at each terminal, an AB diblock copolymer having a diblock structure comprising one segment A and one segment B, and the like.

The monovinyl-substituted aromatic compound refers to a compound in which a functional group containing a vinyl group is bonded to an aromatic ring. Typical examples of the aromatic ring include a benzene ring (which can be a benzene ring substituted with a functional group (e.g., an alkyl group) containing no vinyl groups). Examples of the monovinyl-substituted aromatic compound include styrene, α-methyl styrene, vinyl toluene, vinyl xylene, and the Eke. Examples of the conjugated diene compound include 1,3-butadiene, isoprene, and the like. Among such block copolymers, one species can be used solely, or two or more species can be used together as the base polymer.

Segment A (hard segment) in the block copolymer comprises the monovinyl-substituted aromatic compound (for which, two or more species can be used together) at a copolymerization ratio of preferably 70% by mass or greater (more preferably 90% by mass or greater, or it can be essentially 100% by mass). Segment B (soft segment) in the block copolymer comprises the conjugated diene compound (for which, two or more species can be used) at a copolymerization ratio of preferably 70% by mass or greater (more preferably 90% by mass or greater, or it can be essentially 100% by mass). According to such a block copolymer, a PSA sheet of higher performance can be obtained.

The block copolymer may be a diblock copolymer, a triblock copolymer, a radial copolymer, a mixture of these, or the like. In a triblock copolymer or a radial copolymer, it is preferable that segment A (e.g., a styrene block) is placed at a terminal of the polymer chain. Segment A placed terminally on the polymer chain is likely to aggregate to form a domain, whereby pseudo crosslinks are formed, resulting in increased cohesive strength of the PSA.

In the art disclosed herein, from the standpoint of the peel strength to an adherend, a preferable block copolymer has a diblock fraction of 30% by mass or greater (more preferably 40% by mass or greater, even more preferably 50% by mass or greater, or especially preferably 60% by mass or greater, typically 65% by mass or greater). From the standpoint of the peel strength, a particularly preferable block copolymer has a diblock fraction of 70% by mass or greater. From the stand point of the cohesive strength, etc., can be used a block copolymer having a diblock fraction of preferably 90% by mass or smaller (more preferably 85% by mass or smaller, e.g. 80% by mass or smaller). For instance, a preferable block copolymer has a diblock fraction of 60 to 85% by mass, or more preferably 70 to 85% by mass (e.g. 70 to 80% by mass).

When the PSA disclosed herein is a rubber-based PSA, the amount of polymer(s) besides the rubber-based polymer is, relative to 100 parts by mass of the base polymer, suitably 50 parts by mass or less, preferably 30 parts by mass or less, or more preferably 10 parts by mass or less (e.g. 5 parts by mass or less). The art disclosed herein can be preferably implemented in an embodiment where the base polymer of the PSA essentially consists of a rubber-based polymer (e.g. an embodiment where the rubber-based polymer content in 100 parts by mass of the base polymer is 99 to 100 parts by mass).

### <Styrene-Based Block Copolymer>

In a preferable embodiment of the art disclosed herein, the base polymer is a styrene-based block copolymer. Herein, the term “styrene-based block copolymer” refers to a polymer comprising at least one styrene block. The “styrene block” refers to a segment comprising styrene as a primary monomer. A typical example of a styrene block referred to herein is a segment consisting essentially of styrene. “Styrene-isoprene block copolymer” refers to a polymer comprising at least one styrene block and at least one isoprene block (a segment comprising isoprene as a primary monomer). Typical examples of a styrene-isoprene block copolymer include a triblock copolymer having a triblock structure where an isoprene block (soft segment) is coupled to a styrene block (hard segment) at each terminal, a diblock copolymer having a diblock structure comprising one isoprene block and one styrene block, and the like. “Styrene-butadiene block copolymer” refers to a polymer comprising at least one styrene block and at least one butadiene block (a segment comprising butadiene as a primary monomer).

As the styrene-based block copolymer in the art disclosed herein, for instance, an embodiment wherein the base polymer comprises at least either a styrene-isoprene block copolymer or a styrene-butadiene block copolymer is preferable. It is preferable that the styrene-based block copolymer contained in the PSA comprises either a styrene-isoprene block copolymer at a ratio of 70% by mass or greater, a styrene-butadiene block copolymer at a ratio of 70% by mass or greater, or a styrene-isoprene block copolymer and a styrene-butadiene block copolymer at a combined ratio of 70% by mass or greater. In a preferable embodiment, essentially all (e.g., 95 to 100% by mass) of the styrene-based block copolymer is a styrene-isoprene block copolymer. In another preferable embodiment, essentially all (e.g., 95 to 100% by mass) of the styrene-based block copolymer is a styrene-butadiene block copolymer. According to such compositions, greater effects may be obtained by applying the art disclosed herein.

The styrene-based block copolymer can be a diblock copolymer, a triblock copolymer, a radial copolymer, a mixture of these, or the like. In a triblock copolymer and a radial copolymer, it is preferable that a styrene block is placed at a terminal of the polymer chain. The styrene block placed terminally on the polymer chain is likely to aggregate to form a styrene domain, whereby pseudo crosslinks are formed, resulting in increased cohesive strength of the PSA. In the art disclosed herein, from the standpoint of the peel strength to an adherend, for instance, a preferable styrene-based block copolymer has a diblock fraction of 30% by mass or greater (more preferably 40% by mass or greater, even more preferably 50% by mass or greater, or especially preferably 60% by mass or greater, typically 65% by mass or greater). The styrene-based block copolymer may have a diblock fraction of 70% by mass or larger (e.g., 75% by mass or larger). From the standpoint of the cohesive strength, etc., can be used a styrene-based block copolymer having a diblock fraction of preferably 90% by mass or smaller (more preferably 85% by mass or smaller, e.g., 80% by mass or smaller). From the standpoint of combining various adhesive properties (peel strength, holding power, etc.) at a good balance by applying the art disclosed herein, the styrene-based block copolymer has a diblock fraction of preferably 60 to 85% by mass or more preferably 70 to 85% by mass (e.g. 70 to 80% by mass).

The diblock content (which hereinafter may be referred to as the “diblock fraction” or “diblock ratio”) in a styrene-based block copolymer can be determined by the following method. That is, a given styrene-based block copolymer is dissolved in tetrahydrofuran (THF) and subjected to high-performance liquid chromatography at a temperature of 40° C. with the THF as the mobile phase passing at a flow rate of 1 mL/min through four linearly connected four total columns consisting of two each of liquid chromatography columns GS5000H and G4000H both available from Tosoh Corporation; from the resulting chromatogram, the area of the peak corresponding to the diblock copolymer is determined; and the diblock fraction is determined as the percentage of the area of the peak corresponding to the diblock relative to the total area of all peaks.

The styrene content in the styrene-based block copolymer can be, for instance, 5 to 40% by mass. From the standpoint of the cohesive strength, it is preferable that the styrene content is 10% by mass or greater (more preferably greater than 10% by mass, e.g., 12% by mass or greater). From the standpoint of the peel strength, the styrene content is preferably 35% by mass or less (typically 30% by mass or less, or more preferably 25% by mass or less) or particularly preferably 20% by mass or less (typically, less than 20% by mass, e.g. 18% by mass or less). From the standpoint of obtaining greater effects by applying the art disclosed herein (e.g. effects of increasing the peel strength or holding power), can be preferably used a styrene-based block copolymer having a styrene content of 12% by mass or greater, but less than 20% by mass. As used herein, “the styrene content” in a styrene-based block copolymer refers to the mass fraction of styrene residues contained in the total mass of the block copolymer. The styrene content can be measured by NMR (nuclear magnetic resonance spectroscopy).

### <Tackifier Resin>

The PSA disclosed herein preferably comprises a tackifier resin in addition to the base polymer. As the tackifier resin, can be used one, two or more species selected from various known tackifier resins such as petroleum resins, styrene-based resins, coumarone-indene resins, terpene resins, modified terpene resins, rosin-based resins, rosin-derivative resins, ketone-based resins, and the like.

Examples of petroleum resins include aliphatic (CS-based) petroleum resins, aromatic (C9-based) petroleum resins, aliphatic/aromatic copolymer (C5/C9-based) petroleum resins, hydrogenated products of these (e.g. alicyclic petroleum resins obtainable by hydrogenating aromatic petroleum resins) and the like.

Examples of styrene-based resins include a resin comprising a styrene homopolymer as a primary component, a resin comprising an α-methylstyrene homopolymer as a primary component, a resin comprising a vinyltoluene homopolymer as a primary component, a resin comprising as a primary component a copolymer having a monomer composition that includes two or more species among styrene, α-methylstyrene and vinyltoluene (e.g. an α-methylstyrene/styrene copolymer resin comprising an α-methylstyrene/styrene copolymer as a primary component) and the like.

As a coumarone-indene resin, can be used a resin comprising coumarone and indene as monomers constituting the backbone (main chain) of the resin. Examples of monomers that can be contained in the resin backbone other than coumarone and indene, include styrene, α-methylstyrene, methylindene, vinyltoluene and the like.

Examples of terpene resins include poly-α-pinene, poly-6-pinene, poly-dipentene, etc. Examples of modified terpene resins include those obtainable from these terpene resins via modifications (phenol modification, styrene modification, hydrogenation, hydrocarbon modification, or the like). Specific examples include terpene phenol resins, styrene-modified terpene resins, hydrogenated terpene resins, and the like.

The “terpene phenol resin” refers to a polymer containing terpene residue and phenol residue, and the scope thereof encompasses both a terpene phenol copolymer resin and a phenol-modified terpene resin, with the former being a copolymer of a terpene and a phenolic compound, and the latter being a phenol-modification product of a terpene homopolymer or a terpene copolymer (a terpene resin, typically an unmodified terpene resin). Preferable examples of a terpene constituting the terpene phenol resin include mono-terpenes such as α-pinene, 6-pinene, limonene (including d-limonene, l-limonene, and d/l-limonene (dipentene)), and the like.

Examples of rosin-based resins include unmodified rosins (raw rosins) such as gum rosin, wood rosin, tall-oil rosin, etc.; modified rosins obtainable from these unmodified rosins via a modification such as hydrogenation, disproportionation, polymerization, etc. (hydrogenated rosins, disproportionated rosins, polymerized rosins, other chemically-modified rosins, etc.); and the like. Examples of rosin-derived resins include rosin esters such as unmodified rosins esterified with alcohols (i.e., esterification products of unmodified rosins) and modified rosins (hydrogenated rosins, disproportionated rosins, polymerized rosins, etc.) esterified with alcohols (i.e., esterification products of modified rosins), and the like; unsaturated fatty-acid-modified rosins obtainable from unmodified rosins and modified rosins (hydrogenated rosin, disproportionated rosin, polymerized rosin, etc.) via modifications with unsaturated fatty acids; unsaturated fatty-acid-modified rosin esters obtainable from rosin esters via modifications with unsaturated fatty acids; rosin alcohols obtainable via reduction of carboxyl groups from unmodified rosins, modified rosins (hydrogenated rosins, disproportionated rosins, polymerized rosin, etc.), unsaturated fatty-acid-modified rosins or unsaturated fatty-acid-modified rosin esters; metal salts of rosins including unmodified rosins, modified rosins, various rosin derivatives, etc. (in particular, metal salts of rosin esters); rosin phenol resins obtainable from rosins (unmodified rosins, modified rosins, various rosin derivatives, etc.) via addition of phenol in the presence of an acid catalyst followed by thermal polymerization; and so on.

### <High Softening Point Resin>

The PSA disclosed herein preferably comprises a tackifier resin (high softening point resin) TH having a softening point of 120° C. or above as the tackifier resin. From the standpoint of the cohesive strength, etc., the softening point of high softening point resin TH is preferably 125° C. or above, more preferably 130° C. or above, or even more preferably 135° C. or above (e.g. 140° C. or above). From the standpoint of the peel strength to an adherend, etc., the softening point of high softening point resin TH is suitably about 200° C. or below, preferably 180° C. or below, or more preferably 170° C. or below (e.g. 160° C. or below).

The softening point of a tackifier resin disclosed herein is defined as a value measured based on the softening point test method (ring and ball method) specified in JIS K5902 and JIS K2207. In particular, a sample is quickly melted at a lowest possible temperature, and with caution to avoid bubble formation, the melted sample is poured into a ring to the top, with the ring being placed on top of a flat metal plate. After cooled, any portion of the sample risen above the plane including the upper rim of the ring is sliced off with a small knife that has been somewhat heated. Following this, a support (ring support) is placed in a glass container (heating bath) having a diameter of 85 mm or larger and a height of 127 mm or larger, and glycerin is poured into this to a depth of 90 mm or deeper. Then, a steel ball (9.5 mm diameter, weighing 3.5 g) and the ring filled with the sample are immersed in the glycerin while preventing them from touching each other, and the temperature of glycerin is maintained at 20° C.±5° C. for 15 minutes. The steel ball is then placed at the center of the surface of the sample in the ring, and this is placed on a prescribed location of the support. While keeping the distance between the ring top and the glycerin surface at 50 mm, a thermometer is placed so that the center of the mercury ball of the thermometer is as high as the center of the ring, and the container is heated evenly by projecting a Bunsen burner flame at the midpoint between the center and the rim of the bottom of the container. After the temperature has reached 40° C. from the start of heating, the rate of the bath temperature rise must be kept at 5° C.±0.5° C. per minute. As the sample gradually softens, the temperature at which the sample flows out of the ring and finally touches the bottom plate is read as the softening point. Two or more measurements of softening point are performed at the same time, and their average value is used.

In the PSA disclosed herein, as a high softening point resin TH, can be used, for instance, a terpene phenol resin, rosin phenol resin, polymerized rosin, esterification product of a polymerized rosin and the like. These high softening point resins can be used singly as one species or in combination of two or more species. Preferable embodiments include an embodiment comprising one, two or more species of terpene phenol resin as the high softening point resin TH. A terpene phenol resin having a softening point of 120° C. or above, but 200° C. or below (typically 120° C. or above, but 180° C. or below, e.g. 125° C. or above, but 170° C. or below) can preferably be used. Too low a softening point may lead to a tendency of lower holding power. Too high a softening point may result in a tendency of poorer peel strength to an adherend.

Although not particularly limited, examples of preferable embodiments include an embodiment where 25% by mass or more (more preferably 30% by mass or more) of the high softening point resin TH is a terpene phenol resin. 50% by mass or more (more preferably 70% by mass or more, even more preferably 80% by mass or more, e.g. 90% by mass or more) of the high softening point resin TH may be a terpene phenol resin. Essentially all (e.g. 95% by mass or more) the high softening point resin TH may be a terpene phenol resin.

The art disclosed herein can be preferably implemented, for instance, in an embodiment comprising, as the high softening point resin TH, a tackifier resin (high softening point resin) T_{H1} having a hydroxyl value of 80 mgKOH/g or higher (e.g. 90 mgKOH/g or higher). The hydroxyl value of the high softening point resin T_{H1} is typically 200 mgKOH/g or lower, or preferably 180 mgKOH/g or lower (e.g. 160 mgKOH/g or lower). According to a PSA comprising a high softening point resin T_{H1}, a PSA sheet of higher performance may be obtained. A PSA sheet may be obtained, combining cohesive strength (e.g. high temperature cohesive strength) and other properties (e.g. peel strength) at a higher level. In the art disclosed herein, the high softening point resin T_{H1} is used more preferably in combination with the rubber-based polymer as the base polymer and particularly preferably in combination with a base polymer comprising a block copolymer of a monovinyl-substituted aromatic compound and a conjugated diene compound.

As the “hydroxyl value” in this description, can be used a value measured by the potentiometric titration method specified in JIS K0070:1992. Details of the method are described below.

[Method for Measuring Hydroxyl Value]

### 1. Reagents

(1) As the acetylation reagent, is used a solution prepared by mixing with sufficient stirring about 12.5 g (approximately 11.8 mL) of anhydrous acetic acid and pyridine added up to a total volume of 50 mL. Alternatively, is used a solution prepared by mixing with sufficient stirring about 25 g (approximately 23.5 mL) of anhydrous acetic acid and pyridine up to a total volume of 100 mL.
(2) As the titrant, is used a 0.5 mol/L potassium hydroxide (KOH) solution in ethanol.
(3) For others, toluene, pyridine, ethanol and distilled water should be ready for use.

### 2. Procedures

(1) Approximately 2 g of analyte is accurately weighed out in a flat-bottom flask, 5 mL of the acetylation reagent and 10 mL of pyridine are added, and an air condenser is placed on.
(2) The flask is heated in a bath at 100° C. for 70 minutes and then cooled. From the top of the condenser, 35 mL of toluene is added as a solvent and stirred. Subsequently, 1 mL of distilled water is added and the resultant is stirred to decompose any remaining anhydrous acetic acid. The flask is heated in the bath again for 10 minutes to complete the decomposition and then cooled.
(3) After rinsed with 5 mL of ethanol, the condenser is removed. Subsequently, 50 mL of pyridine is added as a solvent and the resultant is stirred.
(4) Using a volumetric pipette, is added 25 mL of the 0.5 mol/L KOH ethanol solution.
(5) Potentiometric titration is carried out with the 0.5 mol/L KOH ethanol solution. The inflection point in the resulting titration curve is taken as the final point.
(6) For a blank titration, procedures (1) to (5) are carried out without addition of the analyte.

### 3. Calculations

The hydroxyl value is calculated by the following equation:

Hydroxyl value(mgKOH/g)=[(B−C)×f×28.05]/S+D

wherein:

B is the volume (mL) of the 0.5 mol/L KOH ethanol solution used in the blank titration;

C is the volume (mL) of the 0.5 mol/L KOH ethanol solution used to titrate the analyte;

f is the factor of the 0.5 mol/L KOH ethanol solution;

S is the mass of analyte (g);

D is the acid value;

28.05 is one half the molecular weight of KOH.

As the high softening point resin T_{H1}, can be used one species solely or a suitable combination of two or more species among the various high softening point resins Tx having hydroxyl values of the prescribed value or higher. In a preferable embodiment, as the high softening point resin T_{H1}, at least a terpene phenol resin is used. A terpene phenol resin is preferable since its hydroxyl value can be controlled at will by means of the copolymerization ratio of phenol. Preferably, 50% by mass or more (more preferably 70% by mass or more, e.g. 90% by mass or more) of the high softening point resin T_{H1} is a terpene phenol resin. Essentially all (e.g. 95 to 100% by mass, or even 99 to 100% by mass) may be a terpene phenol resin.

The PSA disclosed herein may comprise, as the high softening point resin TH, a tackifier resin (high softening point resin) T_{H2} having a hydroxyl value of 0 mgKOH/g or higher, but below 80 mgKOH/g. A high softening point resin T_{H2} may be used in place of or in combination with a high softening point resin T_{H1}. A preferable embodiment comprises a high softening point resin T_{H1} having a hydroxyl value of 80 mgKOH/g or higher and a high softening point resin T_{H2}. In particular, it is more preferable to use the rubber-based polymer as a base polymer in combination with high softening point reins T_{H1} and T_{H2}. It is particularly preferable to use a block copolymer of a monovinyl-substituted aromatic compound and a conjugated diene compound as a base polymer in combination with high softening point resins T_{H1} and T_{H2}. As the high softening point resin T_{H2}, among the various high softening point resins listed earlier, can be used solely one species having a hydroxyl value in the cited range, or a two or more such species in a suitable combination. For example, can be used a terpene phenol resin, a petroleum resin (e.g., C5-based petroleum resins), a terpene resin (e.g., 6-pinene polymers), a rosin-based resin (e.g., polymerized rosins), a rosin-derivative resin (e.g., esterification products of polymerized rosins), or the like, each having a hydroxyl value of zero or larger, but lower than 80 mgKOH/g.

The art disclosed herein can be practiced preferably in an embodiment wherein the PSA comprises a high softening point resin T_{H1} having a hydroxyl value of 80 mgKOH/g or higher (typically 80 mgKOH/g to 160 mgKOH/g, e.g. 80 mgKOH/g to 140 mgKOH/g) in combination with a high softening point resin T_{H2} having a hydroxyl value of 0 mgKOH/g or higher, but lower than 80 mgKOH/g (typically 40 mgKOH/g or higher, but lower than 80 mgKOH/g). In this case, the relative amounts of T_{H1} and T_{H2} used can be selected, for instance, to have a mass ratio (T_{H1}:T_{H2}) in a range of 1:5 to 5:1 while it is suitable to select them so that their mass ratio is in a range of 1:3 to 3:1 (e.g. 1:2 to 2:1). In a preferable embodiment, each of T_{H1} and T_{H2} is a terpene phenol resin.

The PSA disclosed herein may comprise, as the high softening point resin TH, a tackifier resin (high softening point resin) T_{HR1} having an aromatic ring while having a hydroxyl value of 30 mgKOH/g or lower according to the purpose or intended use. This can effectively improve the cohesive strength (e.g. high temperature cohesive strength). Use of the tackifier resin T_{HR1} is also preferable particularly in increasing the adhesiveness to polishing pad (typically increasing shear adhesive strength) and decreasing temperature dependence of the adhesiveness to polishing pad (typically, 180° peel strength). For the tackifier resin T_{HR1}, solely one species or a combination of two or more species can be used. The hydroxyl value of tackifier resin T_{HR1} is preferably lower than 10 mgKOH/g, more preferably lower than 5 mgKOH/g, or even more preferably lower than 3 mgKOH/g. For example, a preferable tackifier resin T_{HR1} has a hydroxyl value below 1 mgKOH/g or has no detectable hydroxyls.

Examples of a tackifier resin having an aromatic ring include the aromatic petroleum resins, aliphatic/aromatic copolymer-based petroleum resins, styrene-based resins, coumarone-indene resins, styrene-modified terpene resins, phenol-modified terpene resins, and rosin phenol resins described earlier, and the like. Among these, as the tackifier resin T_{HR1}, can be used a resin having a softening point of 120° C. or above (preferably 130° C. or above, e.g. 135° C. or above) while having a hydroxyl value of 30 mgKOH/g or lower (preferably lower than 5 mgKOH/g, e.g. lower than 1 mgKOH/g).

Preferable examples of materials usable as the tackifier resin T_{HR1} include aromatic petroleum resins, aliphatic/aromatic copolymer-based petroleum resins, styrene-based resins and coumarone-indene resins. A preferable aliphatic/aromatic copolymer-based petroleum resin has a copolymerization ratio of C5 fractions below 15% by mass (more preferably below 10% by mass, even more preferably below 5% by mass, e.g. below 3% by mas). A preferable one has a copolymerization ratio of C9 fractions of 55% by mass or higher (more preferably 60% by mass or higher, even more preferably 65% by mass or higher). Particularly preferable tackifier resins T_{HR1} include aromatic petroleum resins and styrene-based resins (e.g. α-methylstyrene/styrene copolymer resin).

The amount of tackifier resin T_{HR1} used is not particularly limited and it can be suitably selected according to the purpose or intended use of the PSA. From the standpoint of the cohesive strength (e.g. high temperature cohesive strength), the amount of tackifier resin T_{HR1} used relative to 100 parts by mass of the base polymer is preferably 5 parts by mass or greater, or more preferably 10 parts by mass or greater. From the standpoint of combining cohesive strength (e.g. high temperature cohesive strength) and peel strength at a high level, the amount of tackifier resin T_{HR1} used relative to 100 parts by mass of the base polymer can be, for instance, 100 parts by mass or less while it is preferably 80 parts by mass or less (e.g. 60 parts by mass or less). In view of the adhesive properties (e.g. peel strength) at low temperatures, the amount of tackifier resin T_{HR1} used relative to 100 parts by mass of the base polymer is preferably 40 parts by mass or less, or more preferably 30 parts by mass or less (e.g. 25 parts by mass or less).

Although not particularly limited, in an embodiment wherein the base polymer is a styrene-based block copolymer, the amount of tackifier resin T_{HR1} used relative to 1 part by mass of styrene in the block copolymer can be, for instance, 0.1 part by mass or greater. From the standpoint of the cohesive strength (e.g. high temperature cohesive strength), it is preferably 0.2 part by mass or greater, or more preferably 0.5 part by mass or greater. The amount of tackifier resin T_{HR1} used relative to 1 part by mass of styrene in the block copolymer can be, for instance, 10 parts by mass or less. From the standpoint of combining cohesive strength (e.g. high temperature cohesive strength) and peel strength at a high level, it is preferably 7 parts by mass or less, or more preferably 5 parts by mass or less.

In one of the other preferable embodiments of the PSA disclosed herein, the high softening point resin TH may comprise a tackifier resin (high softening point resin) T_{HR2} having an aromatic ring, but essentially free of isoprene units, terpene structures and rosin structures. This can effectively improve the cohesive strength (e.g. high temperature cohesive strength). Use of the tackifier resin T_{HR2} is also preferable particularly in increasing the adhesiveness to polishing pad (typically increasing shear adhesive strength) and decreasing temperature dependence of the adhesiveness to polishing pad (typically, 180° peel strength). For the tackifier resin Time, solely one species or a combination of two or more species can be used. Herein, the tackifier resin T_{HR2} being essentially free of isoprene units, terpene structures and rosin structures refers to that the combined ratio of these structural moieties (i.e. isoprene units, terpene structures and rosin structures) in the tackifier resin T_{HR2} is below 10% by mass (more preferably below 8% by mass, more preferably below 5% by mass, e.g. below 3% by mass). The ratio can be zero % by mass. The isoprene unit content, terpene structure content and rosin structure content in the tackifier resin T_{HR2} can be measured, for instance, by NMR (nuclear magnetic resonance spectrometry).

Examples of a tackifier resin having an aromatic ring, but essentially free of isoprene units, terpene structures and rosin structures include the aromatic petroleum resins, aliphatic/aromatic copolymer-based petroleum resins, styrene-based resins, coumarone-indene resins described above and the like. Among these, one having a softening point of 120° C. or above (preferably 130° C. or above; e.g. 135° C. or above) can be used as the tackifier resin T_{HR2}. Particularly preferable tackifier resins T_{HR2} include aromatic petroleum resins and styrene-based resins (e.g. α-methylstyrene/styrene copolymer resin).

The amount of tackifier resin T_{HR2} used is not particularly limited and it can be suitably selected according to the purpose or intended use of the PSA. From the standpoint of the cohesive strength (e.g. high temperature cohesive strength), the amount of tackifier resin T_{HR2} used relative to 100 parts by mass of the base polymer is preferably 5 parts by mass or greater, or more preferably 10 parts by mass or greater. From the standpoint of combining cohesive strength (e.g. high temperature cohesive strength) and peel strength at a high level, the amount of tackifier resin T_{HR2} used relative to 100 parts by mass of the base polymer can be, for instance, 100 parts by mass or less while it is preferably 80 parts by mass or less (e.g. 60 parts by mass or less). From the standpoint of the adhesive properties (e.g. peel strength) at low temperatures, the amount of tackifier resin T_{HR2} used relative to 100 parts by mass of the base polymer is preferably 40 parts by mass or less, or more preferably 30 parts by mass or less (e.g. 25 parts by mass or less).

Although not particularly limited, in an embodiment wherein the base polymer is a styrene-based block copolymer, the amount of tackifier resin T_{HR2} used relative to 1 part by mass of styrene in the block copolymer can be, for instance, 0.1 part by mass or greater. From the standpoint of the cohesive strength (e.g. high temperature cohesive strength), it is preferably 0.2 part by mass or greater, or more preferably 0.5 part by mass or greater. The amount of tackifier resin T_{HR2} used relative to 1 part by mass of styrene in the block copolymer can be, for instance, 10 parts by mass or less. From the standpoint of combining cohesive strength (e.g. high temperature cohesive strength) and peel strength at a high level, it is preferably 7 parts by mass or less, or more preferably 5 parts by mass or less.

Although not particularly limited, for similar reasons as the tackifier resin T_{HR2}, a preferable tackifier resin T_{HR2} has a hydroxyl value of 30 mgKOH/g or lower (preferably below 5 mgKOH/g, e.g. below 1 mgKOH/g). Accordingly, as the tackifier resin T_{HR2} in the art disclosed herein, those that qualify as the tackifier resin T_{HR2} can be preferably used. Similarly, as the tackifier resin T_{HR2} in the art disclosed herein, those that qualify as the tackifier resin T_{HR2} can be preferably used.

When the PSA disclosed herein comprises a terpene phenol resin as a high softening point resin TH, 25% by mass or more (more preferably 30% by mass or more) of the entire high softening point resin TH is preferably the terpene phenol resin. 50% by mass or more (more preferably 70% by mass r more, even more preferably 80% by mass or more, e.g. 90% by mass or more) of the high softening point resin TH may be a terpene phenol resin. Essentially all (e.g. 95% by mass or more) of the high softening point resin TH may be a terpene phenol resin. For instance, the high softening point resin TH may consist essentially of a terpene phenol resin A and a terpene phenol resin B described later.

When a terpene phenol resin is included as a high softening point resin TH, the PSA disclosed herein can be made preferably in an embodiment comprising 20 parts by mass or more (preferably 35 parts by mass or more, e.g. 40 parts by mass or more) of a terpene phenol resin relative to 100 parts by mass of the base polymer. The terpene phenol resin content is usually suitably 100 parts by mass or less (preferably 80 parts by mass or less, e.g. 70 parts by mass or less).

In the art disclosed herein, although not particularly limited, when a high softening point resin TH is used, from the stand point of the cohesive strength (e.g. high temperature cohesive strength), the total amount of the high softening point resin TH (i.e. the total amount of tackifier resin(s) having a softening point of 120° C. or above) relative to 100 parts by mass of the base polymer can be, for instance, 10 parts by mass or more, or preferably 20 parts by mass or more (more preferably 25 parts by mass or more, e.g. 35 parts by mass or more, typically 40 parts by mass or more). From the standpoint of the peel strength or low temperature properties (e.g. low temperature peel strength), etc., the high softening point resin TH content relative to 100 parts by mass of the base polymer is usually suitably 120 parts by mass or less, preferably 100 parts by mass or less, more preferably 80 parts by mass or less (e.g. 70 parts by mass or less, typically 60 parts by mass or less). With the total amount of the high softening point resin TH being 55 parts by mass or less (e.g. 50 parts by mass or less) relative to 100 parts by mass of the base polymer, greater peel strength may be obtained.

There are no particular limitations to the high softening point resin TH content in all the tackifier resin(s) that can be contained in the PSA disclosed herein. The TH content can be, for instance, 30 to 90% by mass, or preferably 50 to 80% by mass. The art disclosed herein can be implemented in an embodiment where the PSA is free of a high softening point resin TH.

### <Low Softening Point Resin T_{L}>

Other preferable examples of an embodiment comprising optional tackifier resin(s) include an embodiment comprising a tackifier resin (low softening point resin) T_{L} having a softening point below 120° C. According to such an embodiment, for instance, a PSA sheet having greater peel strength can be obtained. The lower limit of the softening point of low softening point resin T_{L} is not particularly limited. One having a softening point of 40° C. or above (typically 60° C. or above) can be preferably used. From the standpoint of combining cohesive strength and peel strength at a high level, a low softening point resin T_{L} having a softening point of 80° C. or above (more preferably 100° C. or above), but below 120° C. can be preferably used. In particular, it is preferable to use a low softening point resin T_{L} having a softening point of 110° C. or above, but below 120° C. The low softening point resin T_{L} is used particularly preferably in combination with the aforementioned high softening point resin TH. The low softening point resin T_{L} is used more preferably in combination with the rubber-based polymer as the base polymer and particularly preferably in combination with a block copolymer of a monovinyl-substituted aromatic compound and a conjugated diene compound as the base polymer.

The hydroxyl value and the structure (e.g. the presence of an aromatic ring, presence of isoprene units, presence of terpene structures, presence of rosin structures, etc.) of low softening point resin T_{L} are not particularly limited. A suitable one can be selected and used among the various tackifier resins (petroleum resins, styrene-based resins, coumarone-indene resins, terpene resins, modified terpene resins, rosin-based resins, rosin-derivative resins, ketone-based resins, etc.) described earlier with them having a softening point below 120° C.

The art disclosed herein can be preferably practiced in an embodiment wherein the PSA comprises, as a low softening point resin T_{L}, at least either a petroleum resin or a terpene resin. For instance, can be preferably employed a composition wherein the primary component (i.e., a component accounting for more than 50% by mass) of the low softening point resin T_{L} is a petroleum resin, a terpene resin, a combination of a petroleum resin and a terpene resin, or the like. From the standpoint of the peel strength and the compatibility, in a preferable embodiment, the primary component of the low softening point resin T_{L} is a terpene resin (e.g., poly-6-pinene). Essentially all (e.g., 95% by mass or more) of the low softening point resin T_{L} can be a terpene resin.

When the PSA disclosed herein comprises a low softening point resin T_{L}, the total amount of low softening point resin T_{L} relative to 100 parts by mass or the base polymer is not particularly limited while it can be, for instance, 10 parts by mass or greater. From the standpoint of the peel strength, it is preferably 15 parts by mass or greater, or more preferably 20 parts by mass or greater. From the standpoint of the cohesive strength, the total amount of low softening point resin T_{L} relative to 100 parts by mass of the base polymer is suitably 120 parts by mass or less, preferably 90 parts by mass or less, or more preferably 70 parts by mass or less (e.g. 60 parts by mass or less). The low softening point resin T_{L} content can be 50 parts by mass or less (e.g. 40 parts by mass or less).

When the PSA disclosed herein comprises a low softening point resin T_{L} and a high softening point resin Tx, their amounts used are preferably selected so that the mass ratio T_{L}:Tx is 1:5 to 3:1 (more preferably 1:5 to 2:1). The art disclosed herein can be practiced preferably in an embodiment wherein the PSA comprises more of Tx than of T_{L} (e.g. the mass ratio T_{L}:Tx is 1:1.2 to 1:5) as the tackifier resin. According to such an embodiment, a PSA sheet of higher performance can be obtained.

There are not particular limitations to the low softening point resin T_{L} content in all the tackifier resins that can be contained in the PSA disclosed herein. The T_{L} content can be, for instance, 10 to 70% by mass, or preferably 20 to 50% by mass. The art disclosed herein can be implemented in an embodiment free of a low softening point resin T_{L}.

<Combination of Terpene Phenol Resins with Different Hydroxyl Values>

The PSA disclosed herein may be made preferably in an embodiment comprising a base polymer consisting of a block copolymer of a monovinyl-substituted aromatic compound and a conjugated diene compound as well as a tackifier resin wherein the tackifier resin comprises at least a terpene phenol resin A and a terpene phenol resin B. Herein, it is preferable to select a terpene phenol resin A and a terpene phenol resin B so that the terpene phenol resin A's hydroxyl value A_{OH} (mgKOH/g) and the terpene phenol resin B's hydroxyl value B_{OH} (mgKOH/g) satisfy a relationship A_{OH}>B_{OH}. The combined use of such terpene phenol resins A and B may lead to improvement, for instance, in the peel strength (especially, long-term peel strength) of the PSA sheet.

It is usually suitable to select terpene phenol resins A and B so that the difference of the hydroxyl values A_{OH} and B_{OH}, that is, A_{OH} minus B_{OH}, is larger than 0 mgKOH/g, but 200 mgKOH/g or smaller. In a preferable embodiment, A_{OH} minus B_{OH} is 5 mgKOH/g to 150 mgKOH/g (typically 10 mgKOH/g to 120 mgKOH/g, more preferably 15 mgKOH/g to 100 mgKOH/g, e.g. 20 mgKOH/g up to 80 mgKOH/g).

The hydroxyl values of the respective terpene phenol resins A and B are not particularly limited. For example, each of A_{OH} and B_{OH} may be 80 mgKOH/g or higher (typically 80 mgKOH/g to 250 mgKOH/g, preferably 80 mgKOH/g to 220 mgKOH/g, e.g. 90 mgKOH/g to 160 mgKOH/g). Each of A_{OH} and B_{OH} may be lower than 80 mgKOH/g (typically 0 mgKOH/g or higher, but lower than 80 mgKOH/g, preferably 10 mgKOH/g or higher, but lower than 80 mgKOH/g, e.g. 20 mgKOH/g to 70 mgKOH/g). Alternatively A_{OH} may be 80 mgKOH/g or higher while B_{OH} is lower than 80 mgKOH/g. In a preferable embodiment, A_{OH} is 80 mgKOH/g or higher (typically 80 mgKOH/g to 160 mgKOH/g, preferably 80 mgKOH/g to 140 mgKOH/g, e.g. 90 mgKOH/g to 120 mgKOH/g) while B_{OH} is lower than 80 mgKOH/g (typically 0 mgKOH/g or higher, but lower than 80 mgKOH/g, preferably 10 mgKOH/g or higher, but lower than 80 mgKOH/g, e.g. 20 mgKOH/g to 70 mgKOH/g), with A_{OH} minus B_{OH} being 10 mgKOH/g or larger (preferably 20 mgKOH/g or larger, e.g. 30 mgKOH/g or larger, but typically 100 mgKOH/g or smaller).

The terpene phenol resin A and B contents can be, respectively 1 part by mass or more relative to 100 parts by mass or the base polymer. To obtain better effects by the combined use of a terpene phenol resin A and a terpene phenol resin B, it is suitable that the terpene phenol resins A and B contents relative to 100 parts by mass of the base polymer are each 5 parts by mass or more (preferably 10 parts by mass or more, e.g. 15 parts by mass or more). From the standpoint of the peel strength (particularly the peel strength at a lower temperature) to an adherend, the total of terpene phenol resins A and B contents is usually suitably 100 parts by mass or less, preferably 90 parts by mass or less, more preferably 80 parts by mass or less (e.g. 70 parts by mass or less) relative to 100 parts by mass of the base polymer. For instance, in a preferable embodiment, the total of the terpene phenol resins A and B contents relative to 100 parts by mass of the base polymer is 15 to 80 parts by mass (typically 25 to 60 parts by mass).

The mass ratio (m_{A}:m_{B}) of the terpene phenol resin A content m_{A} to the terpene phenol resin B content m_{B} can be, for instance, 1:10 to 10:1. From the standpoint of the balance between peel strength to an adherend and peel properties under a constant load (particularly, constant load peel properties in a hot and humid condition), the mass ratio (m_{A}:m_{B}) is suitably 1:5 to 5:1, or it can be, for example, 1:3 to 3:1. In a preferable embodiment, m_{A} and m_{B} can be selected so that the mass ratio m_{A}/m_{B} has a value of 0.7 to 10 (more preferably 0.8 to 5, typically 0.9 to 4, e.g. 1 to 3). According to such an embodiment, a PSA sheet can be obtained with excellent resistance against a continuously-applied stress as well as great adhesive properties (e.g. peel strength) and long-term stability.

The softening points of the respective terpene phenol resins A and B are not particularly limited. For example, the softening points of the terpene phenol resins A and B may be, respectively 120° C. or above (typically above 120° C., preferably 125° C. or above, e.g. 130° C. or above, but typically 180° C. or below), or each can be below 120° C. Alternatively, one of the terpene phenol resins A and B may have a softening point of 120° C. or above while the other may have a softening point below 120° C. In a preferable embodiment, the softening points of the terpene phenol resins A and B are both in a range of 120° C. to 170° C. For example, can be preferably used a terpene phenol resin A having a softening point of 120° C. to 170° C. and a hydroxyl value of 80 mgKOH/g to 140 mgKOH/g in combination with a terpene phenol resin B having a softening point of 120° C. to 170° C. and a hydroxyl value lower than 80 mgKOH/g (e.g. 20 mgKOH/g to 70 mgKOH/g).

The PSA disclosed herein may comprise, as the tackifier resin, another terpene-phenol resin besides terpene-phenol resins A and B. When the PSA comprises three or more species of terpene-phenol resin, between the top two species selected in decreasing order of the amount contained based on the mass among all terpene-phenol resins, terpene-phenol resin A is the one having a higher hydroxyl value and terpene-phenol resin B is the one having a lower hydroxyl value. If three different species of terpene-phenol resin are contained at a mass ratio of approximately 1:1:1 with the three species accounting for the largest amounts based on the mass, terpene-phenol resin A is the one having the highest hydroxyl value and terpene-phenol resin B is the one having the lowest hydroxyl value among the three.

When tackifier resin(s) are used in the art disclosed herein, the total amount of tackifier resin(s) relative to 100 parts by mass of the base polymer is not particularly limited. From the standpoint of obtaining well-balanced cohesiveness and peel strength, it is usually suitably 20 parts by mass or more, preferably 30 parts by mass or more, or more preferably 40 parts by mass or more (e.g. 50 parts by mass or more). From the standpoint of the low temperature properties (e.g. low temperature peel strength), etc., the tackifier resin content relative to 100 parts by mass of the base polymer is usually suitably 200 parts by mass or less, preferably 150 parts by mass or less, or more preferably 120 parts by mass or less (e.g. 100 parts by mass or less).

### <Isocyanate Compound>

A PSA composition used to form the PSA (PSA layer) disclosed herein may comprise an isocyanate compound. According to such a PSA composition, can be obtained a PSA sheet of higher performance (e.g. having excellent repulsion resistance and peel property under a constant load). As the isocyanate compound, can be used preferably a polyfunctional isocyanate (which refers to a compound having an average of two or more isocyanate groups per molecule, including a compound having an isocyanurate structure). As the polyfunctional isocyanate, can be used one, two or more species selected from various isocyanate compounds (polyisocyanates) containing two or more isocyanate groups per molecule. Examples of such a polyfunctional isocyanate include aliphatic polyisocyanates, alicyclic polyisocyanates, aromatic polyisocyanates, and the like.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-1,5-pentane diisocyanate, 3-methyl-1,5-pentane diisocyanate, lysine diisocyanate, and the Eke.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, 4,4′-dicyclohexylmethane diisocyanate, and the like.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, xylylene-1,3-diisocyanate and the like.

A preferable example of an isocyanate compound is a polyfunctional isocyanate having an average of three or more isocyanate groups per molecule. Such a tri-functional or higher polyfunctional isocyanate can be a multimer (typically a dimer or a trimer), a derivative (e.g., an addition product of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, polyester polyisocyanate, and the like. Commercial polyfunctional isocyanates include trade name “DURANATE TPA-100” available from Asahi Kasei Chemicals Corporation; trade names “CORONATE L”, “CORONATE HL”, “CORONATE HK”, “CORONATE HX”, “CORONATE 2096” available from Nippon Polyurethane Kogyo Co., Ltd.; and the like.

When an isocyanate compound is used, its amount used is not particularly limited. For instance, relative to 100 parts by mass of the base polymer, it can be more than zero part by mass, but 10 parts by mass or less (typically 0.01 to 10 parts by mass). In usual, an isocyanate compound can be used in an amount of suitably 0.1 to 10 parts by mass or preferably 0.1 to 5 parts by mass (typically 0.3 to 3 parts by mass, e.g., 0.5 to 1 part by mass) relative to 100 parts by mass of the base polymer. With use of an isocyanate compound in such a range, can be obtained a PSA sheet having particularly well-balanced properties.

### <Other Components>

The PSA disclosed herein may contain as necessary various additives generally used in the PSA field, such as leveling agent, crosslinking agent, crosslinking co-agent, plasticizer, softening agent, filler, colorant (pigment, dye, etc.), anti-static agent, anti-aging agent, ultraviolet light absorber, anti-oxidant, photostabilizing agent, and so on. With respect to these various additives, those heretofore known can be used by ordinary methods. The PSA disclosed herein can be made preferably in an embodiment essentially free of a liquid rubber such as liquid polybutene, etc., (e.g., where the liquid rubber content relative to 100 parts by mass of the base polymer is 1 part by mass or less, or may be even zero part by mass). According to such a PSA, it may be possible to obtain a PSA sheet exhibiting even higher repulsion resistance and/or greater peel property under a constant load.

In a preferable embodiment, the PSA may have a composition where the combined amount of the base polymer and the tackifier resin accounts for 90% by mass or more of the total mass of the PSA (i.e., the mass of a PSA layer constituted with this PSA). For example, in a preferable embodiment, the combined amount of the base polymer and the tackifier resin is 90 to 99.8% by mass (typically, for instance, 95 to 99.5% by mass) of the total mass of the PSA.

In another preferable embodiment, the PSA may have a composition essentially free of a chelate compound. Herein, the chelate compound refers to, for instance, a chelate complex of an alkaline earth metal oxide and a resin (an alkyl phenol resin, etc.) having a functional group (hydroxyl group, methylol group, etc.) capable of coordinating the oxide. The art disclosed herein can be practiced preferably in an embodiment where the PSA composition is free of such a chelate compound or in an embodiment containing none or at most 1% by mass of a chelate compound. According to such an embodiment, it may be possible to obtain a PSA sheet exhibiting even greater adhesive strength.

The form of the PSA composition disclosed herein is not particularly limited, and can be, for instance, a solvent-based PSA composition containing a PSA (an adhesive component) having a composition described above in an organic solvent, a water-dispersed (typically, an aqueous emulsion-based) PSA composition containing a PSA dispersed in an aqueous solvent, a PSA composition of the hot-melt type or the like. From the standpoint of the PSA's applicability and the latitude in the choice of a substrate, etc., a solvent-based or a water-dispersed PSA composition can be used preferably. From the standpoint of obtaining even greater adhesive properties, a solvent-based PSA composition is especially preferable. Such a solvent-based PSA composition can typically be prepared as a solution containing the respective components described above in an organic solvent. The organic solvent can be selected among known or conventional organic solvents. For instance, can be used any one species or a mixture of two or more species among aromatic compounds (typically aromatic hydrocarbons) such as toluene, xylene, etc.; acetic acid esters such as ethyl acetate, butyl acetate, etc; aliphatic or alicyclic hydrocarbons such as hexane, cyclohexane, methyl cyclohexane, etc.; halogenated alkanes such as 1,2-dichloroethane, etc.; ketones such as methyl ethyl ketone, acetyl acetone, etc.; and the like. While not particularly limited, in usual, the solvent-based PSA composition is suitably prepared to have a non-volatile content (NV) of 30 to 65% by mass (e.g., 40 to 55% by mass). Too low an NV tends to result in higher production costs while too high an NV may lower the workability such as the PSA's applicability, etc.

As for the method for obtaining a PSA sheet from a PSA composition, various conventionally known methods can be applied. For example, can be preferably employed a method (direct method) where the PSA composition is directly provided (typically applied) to a substrate and allowed to dry to form a PSA layer. Alternatively, can be employed a method (transfer method) where the PSA composition is provided to a releasable surface (e.g. a surface of a release liner, a release-treated back face of a support substrate, etc.) and allowed to dry to form a PSA layer on the surface, and the PSA layer is transferred to a substrate.

The PSA composition can be applied, for instance, with a known or commonly used coater such as gravure roll coater, reverse roll coater, kiss roll coater, dip roll coater, bar coater, knife coater, spray coater, or the like. From the standpoint of facilitating the crosslinking reaction and increasing the production efficiency, the PSA composition is dried preferably with heating. For example, the drying temperature can be preferably around 40° C. to 150° C. (typically 40° C. to 120° C., e.g. 50° C. to 120° C., or even 70° C. to 100° C.). The drying time is not particularly limited while it can be about a few tens of seconds to a few minutes (e.g. within about 5 minutes, preferably about 30 seconds to 2 minutes). While the PSA layer is typically formed continuously, it may be formed in a regular pattern of dots or stripes, etc., or in a random pattern.

While not particularly limited, from the standpoint of obtaining good adhesive strength, the PSA layer preferably has a thickness of 10 μm or larger (e.g. 30 μm or larger, typically 50 μm or larger). An excessively large thickness of the PSA layer may lead to a tendency of reduced productivity, etc. In such a view, the thickness of the PSA layer is suitably about 300 μm or smaller (e.g. 150 μm or smaller, typically 100 μm or smaller). When the PSA sheet disclosed herein has a first PSA layer and a second PSA layer, in order to increase the adhesive strength of the first PSA layer which may be placed on the polishing pad side, it is preferable that the thickness of the first PSA layer is larger than that of the second PSA layer. The ratio (T1/T2) of the first PSA layer's thickness (T1) to the second PSA layer's thickness (T2) has a value of more preferably 1.2 or larger (e.g. 1.5 or larger, typically 2 or larger).

### <Substrate>

When the art disclosed herein is applied to a substrate-containing, double-faced or single-faced PSA sheet, a suitable substrate can be selected and used according to the intended purpose of the PSA sheet, among plastic films such as polyolefin-based films such as polyethylene (PE) films, polypropylene (PP) films, ethylene-propylene copolymer films and the like, polyester films such as polyethylene terephthalate (PET) films and the like, polyvinyl chloride films, etc.; foam sheets made of foam such as polyurethane foam, polyethylene foam, polychloroprene foam, etc.; woven fabrics and non-woven fabrics (meaning to include paper such as Washi, high-grade paper, etc.) of a single species or a blend, etc., of various species of fibrous substances (which can be natural fibers such as hemp, cotton, etc.; synthetic fibers such as polyester, vinylon, etc.; semi-synthetic fibers such as acetate, etc.; and the like); metal foil such as aluminum foil, copper foil, etc.; and the like. The plastic film (typically referring to a non-porous plastic film, which should be conceptually distinguished from a woven fabric and a non-woven fabric) may be a non-stretched film, or a stretched (uni-axially stretched or bi-axially stretched) film. The substrate surface to be provided with a PSA layer may have been subjected to a surface treatment such as primer coating, corona discharge treatment, or the like. From the standpoint of the workability during application to a polishing pad, the substrate is preferably a plastic film (a typical example is a PET film).

While the thickness of the substrate can be suitably selected according to the purpose, it is generally about 10 μm to 300 μm (typically 25 μm to 100 μm). For example, a PSA sheet having a thickness in these ranges may be easily applied to a larger polishing pad with the benefit of rigidity of the substrate.

### <Overall Thickness of PSA Sheet>

The overall thickness of the PSA sheet disclosed herein (thickness of the PSA sheet excluding any release liner) is not particularly limited. For example, a PSA sheet having a thickness of about 20 μm to 500 μm can be used. The thickness of the PSA sheet can be about 30 μm to 300 μm (e.g. 50 μm to 250 μm) as well. A PSA sheet having such an overall thickness may be, for instance, easily applied to a larger polishing pad.

### <Release Liner>

As the release liner disclosed herein, a conventional release paper or the like can be used without particular limitations. For instance, for a support substrate constituting a release liner (i.e. a substrate subject to a release treatment), a suitable one can be selected and used among various types of resin film, paper, fabrics, rubber sheets, foam sheets, metal foils, a composite of these (e.g. a multi-layer sheet wherein each face of a paper is laminated with an olefin resin) and the like. Release treatment can be carried out by a typical method, using a known or commonly used release agent (e.g. silicone-based, fluorine-based, long-chain alkyl-based release agents, etc.). For instance, can be preferably used a release liner obtainable by subjecting a high-grade paper laminated on each face with a PE resin to a treatment with a silicone-based release agent. Alternatively, a poorly adhesive substrate such as an olefin-based resin (e.g. PE, PP, ethylene-propylene copolymer, PE/PP mixture), fluorine-based polymer (e.g. polytetrafluoroethylene, polyvinylidene fluoride) and the like can be used as the release liner without any release treatment given to the substrate's surfaces. Alternatively, such a poorly adhesive substrate can be used after a release treatment. From the standpoint of the workability, etc., the release liner suitably has a thickness of about 10 μm to 300 μm (e.g. 50 μm to 200 μm, typically 60 μm to 160 μm).

### Examples

Several worked examples relating to the present invention are described below, but the present invention is not intended to be limited to these examples. In the description below, “parts” and “%” are based on the mass unless otherwise specified.

### Example 1

### Preparation of Rubber-Based PSA Composition

100 parts of a styrene-isoprene block copolymer (available from Zeon Corporation, product name “QUINTAC 3520”, 15% styrene content, 78% diblock fraction) as a base polymer, 40 parts of a terpene phenol resin, 30 parts of a terpene resin, 0.75 part by solid content of an isocyanate compound (available from Nippon Polyurethane Industry Co., Ltd., trade name “CORONATE L”), 3 parts of an anti-aging agent, and toluene as a solvent were mixed with stirring to prepare a rubber-based PSA composition A at 50% NV.

Herein, as the terpene phenol resin, two species, namely, trade name “YS POLYSTAR 5145” (softening point 145° C., hydroxyl value 100 mgKOH/g) and trade name “YS POLYSTAR T145” (softening point 145° C., hydroxyl value 60 mgKOH/g) both available from Yasuhara Chemical Co., Ltd., were used at a mass ratio of 1:1 in a combined amount of 40 parts. As for the terpene resin, was used product name “YS RESIN PX1150N” (softening point 115° C., hydroxyl value below 1 mgKOH/g) available from Yasuhara Chemical Co., Ltd. As the anti-aging agent, was used product name “IRGANOX CB612” available from BASF Corporation (a blend of product names “IRGAFOS 168” and “IRGANOX 565” both available from BASF Corporation at a mass ratio of 2:1).

### (Preparation of Acrylic PSA Composition)

Was polymerized a starting monomer mixture consisting of 100 parts of butyl acrylate, 5 parts of vinyl acetate, 3 parts of acrylic acid and 0.1 part of 2-hydroxyethyl acrylate to obtain an acrylic polymer A. To 100 parts of acrylic polymer A, were added as tackifier resins 15 parts of trade name “SUMILITERESIN PR-12603N” (available from Sumitomo Bakelite Co., Ltd.), 10 parts of trade name “RIKATACK PCJ” (available from Harima Chemicals Group, Inc.), 10 parts of trade name “RIKATACK SE10” (available from Harima Chemicals Group, Inc.) and 5 parts of trade name “M-HDR” (available from Wuzhou Sun Shine Forestry and Chemicals Co., Ltd. of Guangxi), and were further added 4 parts of an isocyanate-based crosslinking agent (available from Nippon Polyurethane Industry Co., Ltd., trade name “CORONATE L”) and toluene to form a uniform solution, whereby an acrylic PSA composition A was prepared.

### (Fabrication of PSA Sheet)

As a substrate, a 38 μm thick PET film substrate was obtained. To the first face of the substrate, the rubber-based PSA composition A was applied and dried to form a first PSA layer of about 80 μm thickness. To the first PSA layer, was adhered a release liner (first release liner) treated with a silicone-based release agent. Subsequently, another release liner (second release liner) having the same constitution as the first release liner was obtained. To a surface of the second release liner, the acrylic PSA composition A obtained above was applied and dried to form a second PSA layer of about 40 μm thickness. The second-PSA-layer-side surface was layered (transferred) onto the second face (opposite of the first face) of the PET film substrate. A double-faced PSA sheet according to Example 1 was thus fabricated.

### Example 2

In the same manner as Example 1 except that the thickness of the first PSA layer was modified to 60 μm, a double-faced PSA sheet according to Example 2 was fabricated.

### Example 3

### Preparation of Acrylic PSA Composition B

Into a three-neck flask, were placed 70 parts of butyl acrylate, 30 parts of 2-ethylhexyl acrylate, 3 parts of acrylic acid, 0.05 part of 4-hydroxybutyl acrylate and 152 parts of toluene as a polymerization solvent. Under a nitrogen flow, the resulting mixture was let stir for 2 hours to remove oxygen from the polymerization system. 0.08 part of 2,2′-azobisisobutylonitrile (AIBN) was then added. The mixture was heated to 60° C. and polymerization reaction was carried out for 6 hours. A polymer solution (an acrylic polymer B solution in toluene) was thus obtained. To the polymer solution, relative to 100 parts of the non-volatiles, were added 30 parts of a tackifier resin (a polymerized rosin under trade name “PENSEL D125” available from Arakawa Chemical Industries, Ltd.), 2 parts of an isocyanate-based crosslinking agent (available from Nippon Polyurethane Industry Co., Ltd., trade name “CORONATE L”) and a suitable amount of a polymerization solvent. The resultant was let stir sufficiently to obtain a liquid-form acrylic PSA composition B.

### (Fabrication of PSA Sheet)

The resulting acrylic PSA composition B was applied to a first face of a 75 μm thick PET film substrate and dried to form a first PSA layer of about 70 μm thickness. Otherwise, in the same manner as Example 1, a double-faced PSA sheet according to Example 3 was fabricated.

### Example 4

### Preparation of Thermally Adhesive PSA Composition

To 220 parts of toluene as a solvent, were added 50 parts of a styrene-butadiene-styrene block copolymer (SBS) (available from Asahi Kasei Chemicals Corporation, “ASAPRENE T-420”) and 50 parts of an SBS (available from Asahi Kasei Chemicals Corporation, “ASAPRENE T-432”). The resultant was let stir for about 30 minutes until the SBSs dissolved. To the resulting mixture, were added 100 parts of a tackifier resin (tackifier resin comprising as a primary component an alicyclic saturated hydrocarbon resin available from Arakawa Chemical Industries, Ltd., trade name “ARKON M115”) and 20 parts of a tackifier resin (tackifier resin comprising as a primary component a vinyltoluene-methylstyrene copolymer available from HERCULES Inc., trade name “PICCOTEX #120”). The resultant was let stir for about 30 minutes until the tackifier resins dissolved to obtain a mixture containing the SBSs and tackifier resins dissolved therein.

To 8 parts of isopropanol as a solvent, were added 2 parts of an antioxidant (available from Ouchi Shinko Chemical Industrial Co., Ltd., trade name “NOCRAC NS-6”) and 1 part of an antioxidant (available from Ouchi Shinko Chemical Industrial Co., Ltd., trade name “NOCRAC MB”). The resultant was let stir for several minutes to disperse the antioxidants in the solvent. The resulting antioxidant-containing liquid was added to the mixture including the SBSs and tackifier resins dissolved therein and the resultant was let stir for about 60 minutes. A thermally adhesive PSA composition according to Example 4 was thus obtained.

### (Fabrication of PSA Sheet)

To the first face of a 75 μm thick PET film substrate, the resulting thermally adhesive PSA composition was applied and dried to form a 80 μm thick first PSA layer. The thickness of the second PSA layer was modified to 40 μm. Otherwise, in the same manner as Example 1, a double-faced PSA sheet according to Example 4 was fabricated.

### Example 5

In the same manner as Example 2 except that a 75 μm thick PET film was used as the substrate, a double-faced PSA sheet according to this Example was fabricated.

### Example 6

The rubber-based PSA composition B was prepared in the same manner as the rubber-based PSA composition A of Example 1 except that 20 parts of an aromatic petroleum resin available from JX Nippon Oil & Energy Corporation under product name “NISSEKI NEOPOLYMER 150” (softening point 155° C., hydroxyl value smaller than 1 mgKOH/g) was further added to 100 parts of the base polymer. In the same manner as Example 5 except that a first PSA layer (thickness 60 μm) was formed by using the rubber-based PSA composition B, a double-faced PSA sheet according to this Example was fabricated.

### [180° Peel Strength to Stainless Steel Plate (SUS Adhesive Strength)]

To the second PSA faces (adhesive faces of the second PSA layers) of the double-faced PSA sheets according to Examples 1 to 4, 25 μm thick PET films were adhered, respectively. The resultants were cut to 25 mm wide by 100 mm long to prepare measurement samples. In an environment at 23° C., 50% RH, the first adhesive face (adhesive face of the first PSA layer) of each of the measurement samples was exposed and pressure-bonded to a surface of an adherend with a 2 kg roller moved back and forth once. After this was left standing in the same environment for 30 minutes, using a universal tensile and compression tester (system name “Tensile and Compression Testing Machine, TCM-1kNB” available from Minebea Co., Ltd.), based on JIS Z0237, the peel strength was measured at a peel angle of 180° at a tensile speed of 300 mm/min. The measured value was converted (multiplied by 20 mm/25 mm) to a peel strength per 20 mm of width (N/20 mm-width). As the adherend, a stainless steel plate (SUS304 plate) was used. The measurement was conducted three times and their average value was recorded. The results are shown in Table 1.

[Adhesive Strength after Immersion in Aqueous NaOH Solution]

To the second PSA faces (adhesive faces of the second PSA layers) of the double-faced PSA sheets according to Examples 1 and 2, 25 μm thick PET films were adhered, respectively. The resultants were cut to 25 mm wide by 100 mm long to prepare measurement samples. In an environment at 23° C., 50% RH, the first adhesive face (adhesive face of the first PSA layer) of each of the measurement samples was exposed and pressure-bonded to a surface of a stainless steel plate (SUS304 plate) as the adherend with a 2 kg roller moved back and forth once. The measurement sample was immersed in an aqueous NaOH solution adjusted to pH 11 at 50° C. for three days. The measurement sample was removed from the aqueous solution and washed with water, and any water residue was wiped off. In the same manner as the SUS adhesive strength, based on JIS Z0237, the peel strength (N/20 mm-width) was measured at a peel angle of 180° at a tensile speed of 300 mm/min. The measurement was conducted three times and their average value was recorded. The results are shown as post-NaOH(aq)-immersion SUS adhesive strength in Table 1.

### [180° Peel Strength to Polishing Pad (by Temperatures)]

To the second PSA faces (adhesive faces of the second PSA layers) of the double-faced PSA sheets according to Examples 5 and 6, 25 μm thick PET films were adhered, respectively. The resultants were cut to 25 mm wide by 100 mm long to prepare measurement samples. In an environment at 23° C., 50% RH, the first adhesive face (adhesive face of the first PSA layer) of each of the measurement samples was exposed and pressure-bonded to a surface of an adherend with a 2 kg roller moved back and forth once. After this was left standing in the temperature environment (i.e. 23° C., 40° C., 60° C., or 80° C.) shown in Table 2 for 1 hour, using a universal tensile and compression tester (system name “Tensile and Compression Testing Machine, TCM-1kNB” available from Minebea Co., Ltd.), based on JIS Z0237, the peel strength (N/25 mm-width) was measured at a peel angle of 180° at a tensile speed of 300 mm/min. As the adherend, a commercially available polishing pad (hard urethane-based polishing pad) was used. The measurement was conducted three times and their average value was recorded as adhesive strength to polishing pad. The results are shown in Table 2.

### [Shear Adhesive Strength to Polishing Pad (by Temperatures)]

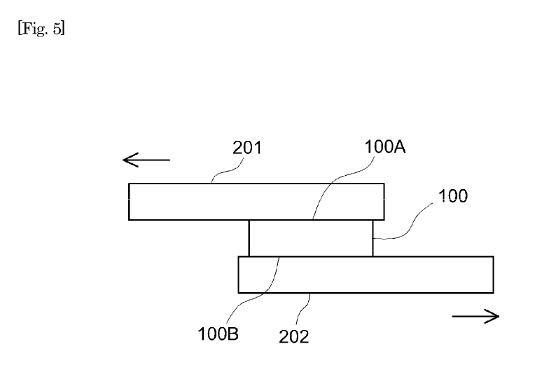

The double-faced PSA sheets according to Examples 5 and 6 were cut to a size of 20 mm×20 mm to prepare measurement samples. In an environment at 23° C., 50% RH, the first adhesive face (adhesive face of the first PSA layer) of each of the measurement samples was placed on a surface of a commercially available polishing pad (hard urethane-based polishing pad), and the second adhesive face (adhesive face of the second PSA layer) of each of the measurement samples was placed on a surface of a stainless steel plate (30 mm×100 mm×0.1 mm thickness), and this was pressure-bonded with a 5 kg roller moved back and forth once. After this was left standing in the temperature environment (i.e. 23° C., 40° C., 60° C., or 80° C.) shown in Table 2 for 1 hour, using a universal tensile and compression tester (system name “Tensile and Compression Testing Machine, TCM-1kNB” available from Minebea Co., Ltd.), peeling was conducted at a peel angle of 0° at a tensile speed of 10 mm/min, and a maximum strength was recorded as shear adhesive strength to polishing pad (N). In particular, as shown in FIG. 5, the first adhesive face 100B of measurement sample 100 was adhered to polishing pad 202, and the second adhesive face 100A of measurement sample 100 was adhered to stainless steel plate 201 and this was pressure-bonded under the condition as described above. After placed in the temperature environment as described above for 1 hour, this was peeled at the above-described speed to a direction (i.e. shear direction) of arrow in FIG. 5 to measure a peel strength (N) per 20 mm×20 mm. The measurement was conducted three times and their average value was recorded. The results are shown in Table 2.

TABLE 1

| | Example 1 | Example 2 | Example 3 | Example 4 |
|---|---|---|---|---|
| Constitution | | | | |
| PSA layer on polishing | Rubber- | Rubber- | Acrylic | Thermally |
| pad side | based | based | | adhesive |
| Thickness (μm) | 80 | 60 | 70 | 80 |
| Adhesive strength to | 36.0 | 30.0 | 22.5 | 28.0 |
| SUS (N/20 mm) | | | | |
| Post-NaOH(aq)- | 65.0 | 49.0 | NA | NA |
| immersion SUS adhesive | | | | |
| strength (N/20 mm) | | | | |

TABLE 2

| | | Example 5 | Example 6 |
|---|---|---|---|
| Adhesive strength | 23° C. | 59 | 55 |
| to polishing pad | 40° C. | 46 | 48 |
| (N/25 mm) | 60° C. | 32 | 35 |
| | 80° C. | 18 | 32 |
| Shear adhesive strength | 23° C. | 200 | 400 |
| to polishing pad | 40° C. | 180 | 370 |
| (N) | 60° C. | 160 | 280 |
| | 80° C. | 75 | 170 |

As shown in Table 1, the PSA sheets according to Examples 1 and 2 exhibited great adhesive strength with SUS adhesive strength values being as high as or higher than 30 N/20 mm. From these results, the PSA sheets according to Examples 1 and 2 are considered to tightly bond to a polishing pad (e.g. foamed polyurethane-based polishing pad). The PSA sheet according to Examples 1 and 2 exhibited post-NaOH(aq)-immersion SUS adhesive strength values of 30 N/20 mm or greater (more specifically 45 N/20 mm or greater). That is, these PSA sheets are considered to have excellent chemical resistance (more specifically base resistance) and continuously exhibit great adhesive strength, for instance, even in an environment where they can be exposed to a basic polishing slurry. Based on the above, it can be said that the PSA sheets according to Examples 1 and 2 are suitable for fastening a polishing pad.

As shown in Table 2, the PSA sheets according to Examples 5 and 6 exhibited strong adhesiveness to the polishing pad (in particular, hard urethane-based polishing pad) in a wide temperature range including normal temperature and high temperature. Especially, in Example 6 where the tackifier resin (in particular, aromatic petroleum resin) corresponding to tackifier resins T_{HR1} and T_{HR2} was used, were exhibited smaller temperature dependence of the adhesive strength to polishing pad in the wide temperature range including high temperature and greater shear adhesive strength in all the measurement temperatures. From these results, it is understood that a PSA sheet wherein a PSA containing tackifier resin T_{HR1} or T_{HR2} was placed on polishing pad side can fasten a polishing pad securely and stably against temperature change in polishing.

As explained above, it can be said that PSA sheets disclosed herein are especially suitable for fastening a polishing pad.

Although specific embodiments of the present invention have been described in detail above, these are merely for illustrations and do not limit the scope of the claims. The art according to the claims includes various modifications and changes made to the specific embodiments illustrated above.

### REFERENCE SIGNS LIST

1, 2, 3 PSA sheet
11 first PSA layer
11A first adhesive face
12 second PSA layer
12A second adhesive face
15 substrate
21, 22 release liner
30 polishing pad
40 polishing machine
50 polishing machine's surface plate

What is claimed is:

1. A pressure-sensitive adhesive sheet for fastening a polishing pad, the pressure-sensitive adhesive sheet comprising a pressure-sensitive adhesive layer constituting an adhesive face of the pressure-sensitive adhesive sheet, wherein
the adhesive face exhibits a 180° peel strength of 30 N/20 mm or greater relative to a stainless steel plate.

2. The pressure-sensitive adhesive sheet according to claim 1, wherein the pressure-sensitive adhesive layer comprises, as a base polymer, a block copolymer of a monovinyl-substituted aromatic compound and a conjugated diene compound.

3. The pressure-sensitive adhesive sheet according to claim 2, wherein the base polymer is a styrene-based block copolymer.

4. The pressure-sensitive adhesive sheet according to claim 1, wherein the pressure-sensitive adhesive layer comprises a tackifier resin, the tackifier resin comprising a high softening point resin having a softening point of 120° C. or above.

5. The pressure-sensitive adhesive sheet according to claim 4, wherein the high softening point resin comprises a terpene phenol resin.

6. The pressure-sensitive adhesive sheet according to claim 4, wherein the tackifier resin comprises a low softening point resin having a softening point below 120° C.

7. The pressure-sensitive adhesive sheet according to claim 1, constituted as an adhesively double-faced pressure-sensitive adhesive sheet comprising a substrate, a first pressure-sensitive adhesive layer as the pressure-sensitive adhesive layer provided on a face of the substrate, and a second pressure-sensitive adhesive layer provided on the other face of the substrate.

8. The pressure-sensitive adhesive sheet according to claim 7, an adhesive face of the first pressure-sensitive adhesive layer being to be bonded to a polishing pad while an adhesive face of the second pressure-sensitive adhesive layer being to be bonded to a surface plate of a polishing machine.

9. The pressure-sensitive adhesive sheet according to claim 2, wherein the pressure-sensitive adhesive layer comprises a tackifier resin, the tackifier resin comprising a high softening point resin having a softening point of 120° C. or above.

10. The pressure-sensitive adhesive sheet according to claim 3, wherein the pressure-sensitive adhesive layer comprises a tackifier resin, the tackifier resin comprising a high softening point resin having a softening point of 120° C. or above.

11. The pressure-sensitive adhesive sheet according to claim 9, wherein the high softening point resin comprises a terpene phenol resin.

12. The pressure-sensitive adhesive sheet according to claim 10, wherein the high softening point resin comprises a terpene phenol resin.

13. The pressure-sensitive adhesive sheet according to claim 5, wherein the tackifier resin comprises a low softening point resin having a softening point below 120° C.

14. The pressure-sensitive adhesive sheet according to claim 9, wherein the tackifier resin comprises a low softening point resin having a softening point below 120° C.

15. The pressure-sensitive adhesive sheet according to claim 10, wherein the tackifier resin comprises a low softening point resin having a softening point below 120° C.

16. The pressure-sensitive adhesive sheet according to claim 11, wherein the tackifier resin comprises a low softening point resin having a softening point below 120° C.

17. The pressure-sensitive adhesive sheet according to claim 12, wherein the tackifier resin comprises a low softening point resin having a softening point below 120° C.

18. The pressure-sensitive adhesive sheet according to claim 2, constituted as an adhesively double-faced pressure-sensitive adhesive sheet comprising a substrate, a first pressure-sensitive adhesive layer as the pressure-sensitive adhesive layer provided on a face of the substrate, and a second pressure-sensitive adhesive layer provided on the other face of the substrate.

19. The pressure-sensitive adhesive sheet according to claim 3, constituted as an adhesively double-faced pressure-sensitive adhesive sheet comprising a substrate, a first pressure-sensitive adhesive layer as the pressure-sensitive adhesive layer provided on a face of the substrate, and a second pressure-sensitive adhesive layer provided on the other face of the substrate.

20. The pressure-sensitive adhesive sheet according to claim 4, constituted as an adhesively double-faced pressure-sensitive adhesive sheet comprising a substrate, a first pressure-sensitive adhesive layer as the pressure-sensitive adhesive layer provided on a face of the substrate, and a second pressure-sensitive adhesive layer provided on the other face of the substrate.
